(19) United States
(12) Patent Application Publication
(10) Pub. No.: US 2024/0390749 A1
(43) Pub. Date: Nov. 28, 2024

(54) Motorcycle Hitch Golf Club Bag Carrier

(71) Applicant: Daniel J. Stallbaumer, Bern, KS (US)

(72) Inventor: Daniel J. Stallbaumer, Bern, KS (US)

(21) Appl. No.: 18/623,709

(22) Filed: Apr. 1, 2024

Related U.S. Application Data
(60) Provisional application No. 63/504,581, filed on May 26, 2023.

(51) Int. Cl. A63B 55/60; A63B 55/40; B62J 11/05

(52) U.S. Cl. CPC A63B 55/61; B62J 11/05; A63B 55/40

(57) ABSTRACT

The motorcycle hitch golf club bag carrier has a hitch coupler that detachably attaches to a hitch receiver of a motored vehicle. A mounting sleeve of the golf bag carrier receives the hitch coupler. The mounting sleeve has a proximal end with a slot and a distal end with a pivot point. A base pan mounted above the mounting sleeve receives a single golf bag. Parallel and adjacent first and second vertical supports extend upwards from the base pan. The vertical supports are mounted perpendicular to the mounting sleeve. The hitch coupler extending horizontally across the diameter of the base pan bisects the vertical supports. A plurality of apertures located along the length of the hitch coupler allow for the golf bag carrier to be adjustably secured towards or away from the proximal end of the hitch coupler.

### CROSS REFERENCES

This application claims the benefit of U.S. Provisional Application No. 63/504,581, filed 26 May 2023.

### REFERENCE TO RESEARCH

Not Applicable.

### REFERENCE TO CDS

Not Applicable.

### FIELD OF THE INVENTION

The present disclosure relates to carriers for golf bags and, more particularly, to a golf bag carrier adapted to be detachably attached to a motor vehicle such as a motorcycle.

### BACKGROUND

Golf bag carriers may be enabled to be carried by motorcycles. However, difficulties are still encountered when attempting to transport golf clubs using a motorcycle.

### SUMMARY

The motorcycle hitch golf club bag carrier, hereinafter referred to as the “golf bag carrier,” has a hitch coupler that easily detaches from and attaches to a hitch receiver. An advantage of this golf bag carrier is the capability of quick installation for hauling a bag containing golf clubs. A mounting sleeve of the golf bag carrier receives the hitch coupler. In the example shown, the mounting sleeve has a proximal end, a distal end, a slot disposed through the proximal end, and a pivot point disposed through the distal end. A base pan is mounted above the mounting sleeve. The base pan is made to receive a single golf bag. A first vertical support extends upward from the base pan. A second vertical support also extends upward from the base pan and is parallel with the first vertical support. The first vertical support and second vertical support are mounted perpendicular to the mounting sleeve. The hitch coupler extends horizontally across the diameter of the base pan and bisects between the first vertical support and the second vertical support. A plurality of apertures are located along the length of the hitch coupler. The advantage to having a plurality of apertures is so that the golf bag carrier may be adjustably secured towards or away from a proximal end of the hitch coupler.

The base pan may have a floor supported by the mounting sleeve or the mounting sleeve may serve as the floor. The floor of the base pan provides upward support against the golf bag being pulled downward by gravity. Alternatively, a horizontal support plate may be mounted between the base pan and the mounting sleeve. A light assembly may be mounted to the base pan to meet safety regulations of the Department of Transportation. The light assembly may be in alignment with the central horizontal line of the mounting sleeve mounted across the diameter of the base pan. A sidewall may extend upwards from the floor. The sidewall may extend between one inch to six inches in height from the floor The sidewall may be cylindrical and coextensive with the periphery of the floor. At least one purpose of the sidewall is to retain a single golf bag received within the base pan. Additionally, an arcuate retainer may extend outwardly from the first vertical support and second vertical support to further retain a golf bag.

The mounting sleeve is operable to pivot between zero degrees and 25 degrees relative to a central horizontal line of the hitch coupler. The mounting sleeve, having received the hitch coupler, can pivot upon the pivot point. The mounting sleeve can then be secured at the slot with a fastener at an angle relative to the central horizontal line of the hitch coupler. The slot may be vertically elongated at a length of between one inch to five inches. The slot may be a pin-and-slot mechanism for quick manual or automatic adjustment.

A central vertical axis passing through a central point of the base pan intersects the central horizontal line of the hitch coupler at a right angle if the mounting sleeve is not pivoted. When the mounting sleeve is pivoted upon the hitch coupler, the central vertical axis through the base pan may intersect the central horizontal line of the hitch coupler to form an obtuse angle of between 90 to 115 degrees. Alternatively, based on the position of the pivot point upon the mounting sleeve, the central vertical axis may intersect the central horizontal to form an acute angle of between 65 degrees to 90 degrees.

The above advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

### BRIEF DESCRIPTION OF DRAWINGS

Aspects are illustrated by way of example, and not by way of limitation, in the accompanying drawings, wherein:

FIG. 1 is a front perspective view of the golf bag carrier supporting a golf bag.

FIG. 2 is a front perspective view of the golf bag carrier without the golf bag.

FIG. 3 is a back view of the golf bag carrier.

FIG. 4 is a bottom view of the golf bag carrier.

FIG. 5 is a top view of the golf bag carrier.

FIG. 6 is an elevation view of the golf bag carrier.

### DETAILED DESCRIPTION

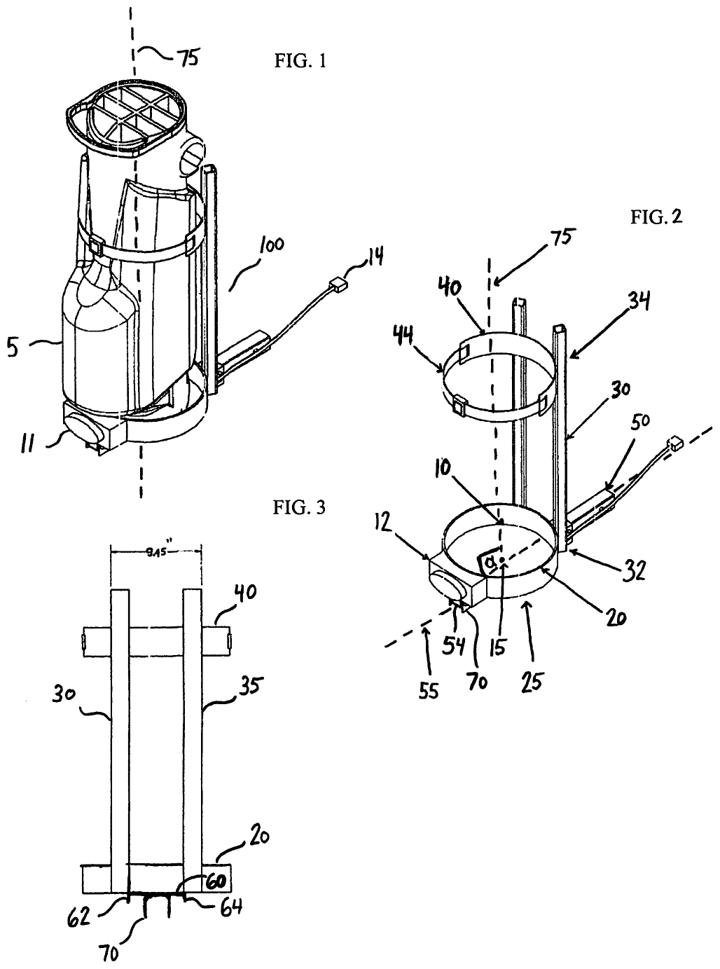

An example of the golf bag carrier 100 is shown in FIG. 1 with a golf bag 5 received. The golf bag 5 shown is a single, upright standing bag devoid of clubs which is supported by the golf bag carrier 100. The golf bag carrier 100 is made from durable materials such as aluminum or steel which may be of solid or hollow construction for attachment to a hitch receiver of a motorcycle. Many types of motorcycles can utilize the golf bag carrier 100 because the hitch coupler 50 can be received by universal hitch receivers. The golf bag carrier 100 can be pivoted at an angle (β) relative to a central horizontal line 55 of a hitch coupler 50 inserted into a hitch receptacle in the rear end of the motorcycle. An aerodynamic advantage occurs with alignment of the golf bag carrier 100 directly behind the motorcycle. Components of the invention include the hitch coupler 50, which is configured to pivot upon a pivot point 73 so that a mounting sleeve 70 supporting the remaining components can be adjustably tilted. The mounting sleeve 70 includes a distal end 74 and a proximal end 72 structured to receive the hitch coupler 50. A slot 71, which may be vertically aligned, is disposed through the proximal end 72. The pivot point 73 is disposed on the distal end 74 of the mounting sleeve 70. Inversely, slot 71 and the pivot point 73 may be disposed through the proximal end 72 so that the distal end 74 of the mounting sleeve 70 pivots upward instead of the proximal end 72.

As shown in FIG. 2, the hitch coupler 50 extends horizontally across the diameter of the base pan 25 on an underside. Motorcycles come in many different styles having different shapes and lengths of rear fenders. Therefore, the hitch coupler 50 has a plurality of apertures disposed through a proximal end 52 of the hitch coupler 50. The plurality of apertures are disposed along the length of the hitch coupler 50 so that the golf bag carrier 100 has adjustable positioning ability nearer or further away from a rear end of a motorcycle. A hitch pin may be inserted through first aperture 48 or second aperture 49 to secure the hitch coupler 50 received by the hitch receiver of the motorcycle at a first position or second position from the rear end of the motorcycle. The plurality of apertures disposed along the length of the hitch coupler 50 may also be used for placement of fasteners through slot 71 and pivot point 73 of the mounting sleeve 70.

As shown in FIG. 2 and FIG. 3, base pan 25 is mounted, which may be welded or bolted, atop the mounting sleeve 70. The base pan 25 is structured to support the base of the golf bag 5. The base pan 25 has a floor 10 that is circular and supported by the mounting sleeve 70. Alternatively, the top surface of the mounting sleeve 70 may serve as the floor of the base pan 25. A sidewall 20 that is cylindrical extends upwards from floor 10. The sidewall 20 of the base pan 25 may be between two inches to six inches in height from floor 10. Further, sidewall 20 may be between three inches to five inches in height. The sidewall 20 may be over six inches in height to retain over half a length of the golf bag 5 within the base pan 25. In such case, a retainer may not be necessary for an upper end of the golf bag 5.

As shown in FIG. 3, a support plate 60 may be disposed between the mounting sleeve 70 and the floor of the base pan 25. The support plate 60 may extend horizontally across the diameter of the base pan 25. The support plate 60 may be greater in width than the mounting sleeve 70, which provides the base pan 25 a structure having a greater surface area to be secured upon. A first folded side 62 and a second folded side 64 of the support plate 60 may extend downwardly over the mounting sleeve 70. A folded side of the support plate 60 may extend downward past a conduit that houses an electrical wire 16 between a light assembly 12 and an electrical connection 14, such as a plug adaptor structured for connection with an electrical receptacle on the rear end of the motorcycle.

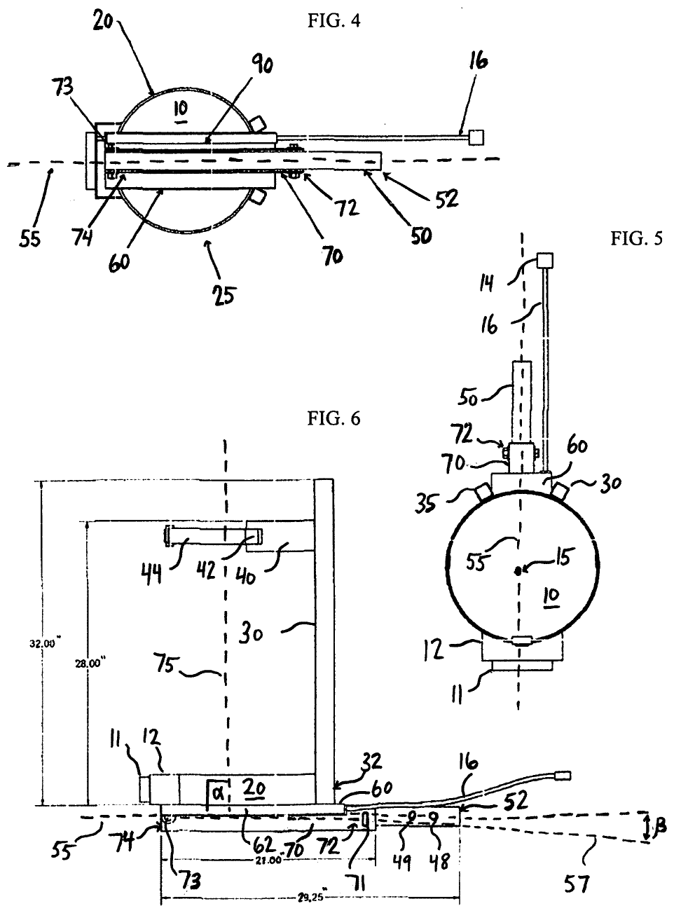

As shown in FIG. 2, FIG. 4, FIG. 5, and FIG. 6, a light assembly 12 is mounted to an outer face of the sidewall 20 of the base pan 25. The light assembly 12 is aligned with the central horizontal line 55 of the hitch coupler 50. The light assembly 12 may be electrically connected to the electrical wire 16. The electrical wire 16 is shown on an underside of the base pan 25 passing through a conduit of tubing on an underside of the horizontal support plate 60 adjacent to a sidewall of the mounting sleeve 70. The light assembly 12 has a brake-turn light 11 which may be operated when the electrical connection 14 is connected to an electrical power source. The brake-turn light 11 may contain incandescent bulbs and/or light-emitting diodes to emit light for the brake, running, and turn signal lights.

As shown in FIG. 2 and FIG. 3, the golf bag carrier 100 includes an upright support assembly having a first vertical support 30 that is adjacent and parallel with a second vertical support 35. The hitch coupler 50 bisects horizontally between the first vertical support 30 and the second vertical support 35. Lower ends 32 of the first vertical support 30 and the second vertical support 35 are shown mounted to the sidewall 20 of the base pan 25. The first vertical support 30 and the second vertical support 35 extend upwardly from the base pan 25 at a perpendicular angle (α) to the mounting sleeve 70. Alternatively, the upright support assembly may be mounted to floor 10 of the base pan 25 or a surface of the mounting sleeve 70.

As shown in FIG. 2 and FIG. 3, an arcuate retainer 40 extends outwardly from the upright support assembly on a side of the golf bag carrier 100 where the base pan 25 resides. The arcuate retainer 40 is configured to retain a golf bag 5 received into the base pan 25. In the example shown, the arcuate retainer 40 is secured to the upper ends 34 of the first vertical support 30 and the second vertical support 35. The ends of the arcuate retainer 40 have attachment points 42 for securing the support strap 44. The support strap 44 may be a flexible strap, with or without a clasp. The support strap 44 may be a bungee strap, rope, seat belt with buckle, Velcro strap, or other suitable strap that can hold an upper end of the golf bag within the arcuate retainer 40. In an alternative example, the arcuate retainer may be lined with Velcro or other fastening device to hold the golf bag 5 within a central vertical axis 75 disposed through a center point 15 of the base pan 25.

As shown in FIG. 2 and FIG. 6, central vertical axis 75 intersects the central horizontal line 55 of the hitch coupler 50 at a right angle (α). The mounting sleeve 70 is operable to pivot upon the hitch coupler 50. Therefore, the golf bag carrier 100 can be adjustably tilted between zero and 25 degrees from the perpendicular axis relative to the central horizontal line 55 of the hitch coupler 55. The mounting sleeve 70 may be pivoted at the pivot point 73 and tilt the central vertical axis 75 away from the central horizontal line 55. The angle (β) formed between the central horizontal line 55 and the central vertical axis 75 may be between 90 degrees to 115 degrees, between 65 degrees to 90 degrees, between 75 degrees to 100 degrees, between 80 degrees to 105 degrees, between 85 degrees to 110 degrees, between 90 degrees to 100 degrees, between 80 degrees to 90 degrees, or between 90 degrees to 105 degrees. If the angle (β) is adjusted to an obtuse of more than 90 degrees, the pivot point 73 position may be disposed through a distal end 74 of the mounting sleeve 70 and the slot 71 disposed through a proximal end 72 of the mounting sleeve 70. If the angle (β) is adjusted to an acute angle of less than 90 degrees, the pivot point 73 may be disposed through the proximal end 72 of the mounting sleeve 70 and the slot 71 disposed through the distal end 74 of the mounting sleeve 70.

As shown in FIG. 6, slot 73 is vertically elongated. The slot 73 may have a length of between one to five inches, between one to four inches, between two to five inches, between one to three inches, between two to four inches, or between two to three inches in vertical length disposed through sidewalls of the mounting sleeve 70. The mounting sleeve 70 may receive fasteners in slot 71 and pivot point 73 for fastening to the hitch coupler 50. The mounting sleeve 70 can then pivot upon the pivot point 73 and be secured at slot 71 at an angle (β) previously discussed above.

It is understood that the invention is not confined to the particular construction and arrangement of parts herein described. That although the drawings and specification set forth a preferred embodiment, and although specific terms are employed, they are used in a description sense only and embody all such forms as come within the scope of the following claims.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims.

For the convenience of the reader, the above description has focused on a representative sample of all possible embodiments, a sample that teaches the principles of the invention and conveys the best mode contemplated for carrying it out. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed variations, modifications and variations are within the literal scope of the following claims, and others are equivalent.

I claim:

1. A golf bag carrier comprising:
a. a hitch coupler;
b. a mounting sleeve structured to receive the hitch coupler, the mounting sleeve including:
i. a proximal end;
ii. a distal end;
iii. a slot disposed through the proximal end;
iv. a pivot point disposed through the distal end;
c. a base pan mounted atop the mounting sleeve and structured to receive a single golf bag;
d. a first vertical support extending upward from the base pan and perpendicular to the mounting sleeve; and
e. wherein the hitch coupler extends horizontally across the diameter of the base pan.

2. The golf bag carrier of claim 1, wherein the base pan further comprises:
a. a floor supported by the mounting sleeve; and
b. a cylindrical sidewall extending upwards between two inches and six inches in height from the floor and configured to retain the single golf bag within the cylindrical sidewall.

3. The golf bag carrier of claim 2, wherein a central vertical axis through the base pan intersects a central horizontal line of the hitch coupler at a right angle.

4. The golf bag carrier of claim 2, wherein a central vertical axis through the base pan intersects a central horizontal line of the hitch coupler to form an angle of between 90 degrees to 115 degrees.

5. The golf bag carrier of claim 1, further comprising:
a. a light assembly mounted to the base pan and in alignment with a central horizontal line of the mounting sleeve.

6. The golf bag carrier of claim 1, wherein the mounting sleeve is operable to pivot between zero and 25 degrees relative to a central horizontal line of the hitch coupler.

7. The golf bag carrier of claim 1, further comprising:
a. an arcuate retainer extending outwardly from the first vertical support and configured to retain the single golf bag.

8. The golf bag carrier of claim 1, wherein the hitch coupler has a plurality of apertures disposed along the length of the hitch coupler.

9. The golf bag carrier of claim 1, further comprising:
a. a second vertical support that is parallel with the first vertical support, wherein the hitch coupler bisects horizontally between the first vertical support and the second vertical support.

10. The golf bag carrier of claim 1, wherein the slot is vertically elongated with a length of between one to five inches.

11. The golf bag carrier of claim 10, wherein the length of the slot is further between two to three inches.

12. The golf bag carrier of claim 1, wherein the mounting sleeve, having received the hitch coupler, can pivot upon the pivot point, and be secured at the slot at an angle relative to a central horizontal line of the hitch coupler.
